(19) United States
(12) Patent Application Publication
(10) Pub. No.: US 2007/0136792 A1
(43) Pub. Date: Jun. 14, 2007

(54) Accelerating biometric login procedures

(76) Inventors: David M.T. Ting, Sudbury, MA (US); Michael Stephen Saulnier, Stoneham, MA (US)

Correspondence Address: GOODWIN PROCTER LLP;PATENT ADMINISTRATOR, EXCHANGE PLACE, BOSTON, MA, 02109-2881, US

(21) Appl. No.: 11/294,354

(22) Filed: Dec. 5, 2005

(51) Int. Cl. H04L 9/32

(52) U.S. Cl. 726/5

(57) ABSTRACT

User authentication requests to computer systems are accelerated by selectively comparing user-provided biometric authentication credentials to a subset of credentials. If the user-supplied credential is not recognized, an alternate form of authentication is requested. Valid login events are used to update the subset such that subsequent authentication requests are handled in an expedited manner.

### FIELD OF THE INVENTION

The present invention relates generally to authentication of users to computer systems and, more specifically, to biometric-based authentication.

### BACKGROUND OF THE INVENTION

The number of computer applications used by large corporations has increased significantly over the past twenty years. For example, companies may employ separate applications for electronic mail, document control, financial applications, inventory management, manufacturing control and engineering functions, in addition to overall network access. Each application often requires a separate login procedure, including some form of personal identification such as a user ID, a password, a key sequence or biometric authentication. The increase in the number of applications requiring user authentication requires significant effort on part of the users of the applications to create, secure, and remember their authentication data. Furthermore, from a management perspective, the proliferation of computer applications with varying security and sign-on procedures adds significant cost to the ongoing maintenance of a secure information technology infrastructure.

The user faces similar login requirements when accessing server-based applications over the Web. For example, the user may face different login procedures (typically involving different passwords) to access bank accounts, brokerage accounts, subscription content sites, etc.

Indeed, the mere need for computer users to keep track of multiple logon names, passwords and PINs in order to access different information further increases the chances of unauthorized use and loss of private information. Users may resort to using the same logon name and password combinations for all accounts, rendering them equally vulnerable if unauthorized access to a single account is obtained. On the other hand, security-conscious users who maintain different logon names and passwords for individual accounts may, to avoid confusion, write them down where they may be found or store them on easily stolen devices such as personal digital assistants—thereby undermining their own efforts. Often those who routinely change their passwords but record them on paper or in a computer file are at greater risk of being compromised than those who use a single but difficult-to-crack password. At the very least, such security-conscious individuals risk forgetting their access information, necessitating time-consuming calls to customer-support lines. In some known systems, different applications may attempt to synchronize their login procedures and user credentials, but this is often limited to applications from particular suppliers and cannot be extended across varying technology platforms.

In response, companies have implemented various “hard” authentication solutions that utilize one or more biometric characteristics attributable to users as a basis for according access to computer resources. Typically, such systems require a user requesting access to a computer system to provide a biometric identifier (e.g., a fingerprint, retinal scan, facial scan, etc.) and subsequently scan a database of valid identifiers for a match; if a match is found, the user's request for access is granted. Unfortunately, the processing resources (and therefore time) required to scan a database containing thousands of biometric identifiers in hopes of finding a match can cause users to experience long, untenable delays during authentication, especially in organizations having multiple locations and thousands of users.

However, the authentication process for computer systems that have relatively few users and possibly less stringent security requirements (such as one's home computer) are generally simple, efficient, and fast. As a result, users have come to expect the authentication process to be virtually instantaneous—often becoming impatient when the process slows or “hangs” due to overburdened processors or other system bottlenecks. This is especially true for computer systems with a large number of users, systems where many users share workstations, or security requirements dictate more intricate login procedures. In response, users may become agitated and repeatedly click or type data into the system, further exacerbating the problem.

What is needed, therefore, is a method and system that provides the secure aspects of biometric authentication without requiring substantial dedicated computing resources and subjecting the users to inconvenient delays during the authentication process.

### SUMMARY OF THE INVENTION

The goal of any user-authentication system is to allow access to valid users and deny access to invalid users with 100% accuracy. However, constraints such as implementation costs and system response times can be barriers to achieving this goal. For example, perfect accuracy could be achieved by maintaining an exhaustive database of biometric-authentication credentials, and subsequently, when a user requests authentication by supplying his fingerprint, for example, the system scans the database (possibly each and every fingerprint) in an attempt to find a match.

The present invention provides techniques and systems that benefit from the enhanced reliability of biometric authentication while not subjecting users to unnecessarily long delays during the login process. The invention exploits the fact that many users generally access secure computer networks and applications from the same physical workstation, logically grouped workstations, and/or physically grouped workstations. Therefore, it is possible to identify a subset of biometric authenticators that, due to historical usage patterns, are more likely to match a particular user's biometric credential. The competing demands of security and response time are thereby balanced without compromising the accuracy of the authentication system.

In one aspect, the present invention provides a method for authenticating a user to a computer system. In accordance with the method, a set of authentication credentials and a valid biometric authentication credential (e.g., a fingerprint, retinal scan, facial scan, or voiceprint) attributed to a user are received. The user-supplied credential is compared to a subset of the biometric authentication credentials, and if the received credential does not match any credentials in the subset, the user is requested to provide an additional (in some cases non-biometric) authentication credential.

An identifier associated with a computer from which the user credential is received, such as a MAC address, IP address and/or a digital signature of the computer can also be received, and in some cases the subset is based on the identifier. Furthermore, the usage history of the computer can be used instead of (or in addition to) the identifier to determine the subset. The additional authentication credentials may be any conventional expedient facilitating user authentication, e.g., a user ID, password, secure token, or any combination thereof, which can subsequently be authenticated, and access to the computer system granted thereon. In some embodiments, the valid biometric authentication credential can be added to or removed from the subset for subsequent queries based on the usage history. Adding the authentication credentials can include adding a record to a database, for example, that associates the credential with the computer from which the initial authentication request emanated, or, in some cases, other computers, based on relationships among the computers and/or their historical usage. The association may then be used to facilitate subsequent user authentication requests using only biometric authentication credentials. In some embodiments, the subset can be based on a group of users that have been granted physical access to a computer that is associated with the computer system.

The subset of valid biometric authentication credentials can be expanded to include additional credentials against which the user's credential is compared, and this process can be repeated until, for example, a time threshold (which in some embodiments can be set by a system administrator or even the user) is reached.

In another aspect, a system for authenticating a user to a secure computer system includes a data storage module for storing a set of valid authentication credentials and a receiver for receiving a biometric authentication credential (e.g., a fingerprint, retinal scan, facial scan, or voiceprint) attributed to a user. The system also includes an authentication module for comparing the biometric authentication credential to a subset of the valid authentication credentials, and if no match is found, requesting the user provide additional authentication information.

In some embodiments, the storage module, receiver, and authentication module reside on a single server, whereas in other embodiments the various modules (or combinations of modules) reside of different servers. The receiver can also receive identifiers associated with the computer, and/or a usage history of the computer, and use either or both to create the subset of the valid authentication credentials. In some cases, the authenticator can also authenticate the user to the computer system based on the additional authentication information provided by the user.

In another aspect, a system for authenticating a user to a computer system includes an authentication agent residing on a computer within a secure computer system. The agent receives biometric authentication credentials from a biometric capture device and, from a server, a subset of biometric authentication credentials representing users (selected from the set of all users) of the computer system. The agent compares the received credential to the subset of the authentication credentials, and, if the received credential does not match any of the credentials in the subset, request the user to provide additional authentication credentials.

In some embodiments, the agent can also receive identifiers associated with the computer, and/or a usage history of the computer, and transmits either or both to a server which may use the information to create the subset of the valid authentication credentials. In some cases, the agent can also authenticate the user to the computer system based on the additional authentication information provided by the user.

In another aspect, the invention provides software in computer-readable form for performing the methods described herein.

### BRIEF DESCRIPTION OF THE DRAWINGS

The foregoing and other objects, features, and advantages of the present invention, as well as the invention itself, will be more fully understood from the following description of various embodiments, when read together with the accompanying drawings, in which:

FIG. 1 is a flow chart depicting a process for authenticating a user to a computer system in accordance with an embodiment of the invention;

FIG. 2 is a flow chart depicting a further adaptation of a process for authenticating a user to a computer system in accordance with an embodiment of the invention;

FIG. 3 represents a data structure used for authenticating a user to a computer system in accordance with an embodiment of the invention;

FIG. 4 represents the data structure of FIG. 3 after being updated in accordance with an embodiment of the invention; and

FIG. 5 schematically depicts a system for authenticating a user to a computer system in accordance with an embodiment of the invention.

### DETAILED DESCRIPTION

One relatively new method for authenticating users includes the use of biometric data as authentication credentials. Biometric data generally represent a unique physical attribute of an individual, and commonly include fingerprints, retinal scans, facial scans, voiceprints, or even DNA. The data can be stored in one or more formats, including (but not necessarily limited to) a graphical image, a binary representation, or an ASCII code. Each time a user requests access to a computer system (e.g., a network, database, or other secured system) the user provides her credential to the system via a capture device such as a scanner or camera. In conjunction with the computer system, a database of valid credentials is maintained that identifies those users that are allowed to access the system. By necessity, however, systems that support hundreds or thousands of users must store valid credentials for each user, some of which may request access from various remote locations. Furthermore, due to the complex nature of the biometric credentials, commonly used data-indexing techniques are often not applicable to biometric data. Thus, absent any technique for accelerating the authentication process, the comparison of the user-supplied criteria to the set of valid criteria becomes an exercise in brute force.

In general, the present invention addresses the shortcomings of conventional authentication systems by recognizing similarities among otherwise unrelated authentication requests, and based on these similarities, reducing the wait time experienced by users during the login authentication process. This is achieved, for example, by capturing and/or analyzing historical workstation usage and other workflow patterns attributable to individual users, allowing the universe of possible authentication credentials against which the user-supplied credential is compared to be minimized and/or controlled. Although the following descriptions and examples describe the invention in the context of authenticating users to computer systems within a large healthcare complex, it is to be understood that the present invention may be applied to user authentication techniques as part of any computer system, without regard to size or context.

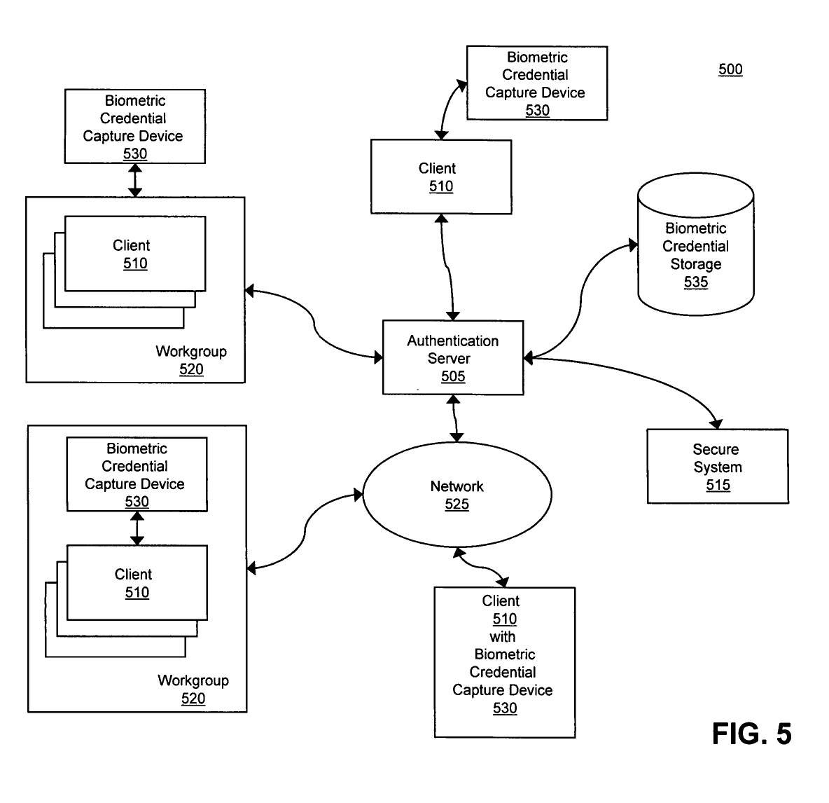

Using the example of a large healthcare facility (such as a hospital) as one possible environment in which the present invention can be deployed, the facility typically has a centralized computer system for storing patient data, scheduling information, reference materials, and the like. The system (described in greater detail below with reference to FIG. 5) comprises one or more servers and workstations, some of which are located in common areas frequented by many staff members. For example, there may be three workstations located at a nursing station, and unlike many conventional office arrangements where a workstation is “assigned” to an individual, the workstations may be used by dozens of staff members such as nurses, technicians and doctors to perform different tasks and access different applications. Because access to the workstations can provide users with the ability to view and/or update sensitive patient data, access to the workstations must be tightly controlled. As described above, requiring the users to provide some form of biometric authentication criteria using a capture device frees the users from having to remember a password or carry an access-control device such as a smart card or hard token, and provides the assurances necessary to comply with data-security and privacy policies. In some embodiments, the capture device may be an integral part of the workstation, while in other cases the device can be separate, and in still other cases a combination of different types of capture devices may be used.

Unlike conventional systems in which the authentication credentials are merely forwarded to a server for verification, the techniques of the present invention provide additional information to be used during the authentication process. When coupled with a user's authentication credential, this information facilitates faster searching of a database of valid biometric authentication credentials, and therefore accelerates user validation and login. Furthermore, because users within an organization tend to use the same (or same set of) workstations over time, when a particular user requests authentication it is likely that they are doing so from a workstation they have used in the past. Thus, by capturing historical workflow and usage data for the user population, the system can quickly identify a subset of authentication credentials that is likely to include the credential attributed to the specific user requesting access.

As an example, computer workstations connected to networks typically have one or more identifiers that are uniquely assigned to the workstation. One such example of an identifier is the Media Access Control (“MAC”) address of a workstation. Other examples include a unique machine name (e.g., XYS312), a static IP address (e.g., 128.64.89.51), as well as others. In some embodiments, it may be possible to identify workstations by a digital signature that is based on static workstation properties such as processor type, rated speed, amount of memory, hard drive, etc as well as dynamic properties such as actual processor or memory transfer speeds. In some cases, the digital signature may be more inclusive than a MAC address, and may utilize more comprehensive matching algorithms, similar to using a “fingerprint” biometric to uniquely identify a machine. In addition, the digital signature has the additional benefit of not being tied to a specific network card. In some embodiments, identifiers may not be uniquely associated with a particular workstation, but instead with a group of workstations that represent a work group, such as a gateway address, a server name to which they are connected, or other logical and/or physical groupings of computers.

As described above, users within an organization tend to use the same (or same set of) workstations over time, and thus when a particular user requests authentication, it is likely that he is doing so from a workstation he has used in the past. In the context of a healthcare facility, for example, a nurse specializing in caring for premature infants is likely to request system access from one of a set of workstations near or in the pediatric ICU, whereas a hospital administrator responsible for ordering and stocking supplies is less likely to request access from such a location. In addition, workflow information (e.g., time of request, location of last request, application(s) used, and data requested) can be captured, analyzed, and used to recognize and define otherwise unobvious computer groupings, or to further pare down the initial set of valid authenticators to a smaller subset.

For example, pairing a user's biometric authentication credential with a workstation identifier (e.g., the MAC address, as described above) and the time of the request allows the system to focus its initial search for a matching credential to a set of users having previously used the same workstation (or a workstation within a defined or logical grouping of computers) at approximately the same time. In the healthcare context, such techniques can be used to limit the initial universe of criteria to nurses that work in a specific area during a particular shift, for example. By limiting the search in this way, the system can quickly filter out hundreds or even thousands of potentially valid credentials, and only perform the more computationally demanding comparison on the remaining subset of credentials.

Other methods of identifying subsets of users can include leveraging information obtained from a physical access system such as a card-based security system. If, for example, the workstations are located within a protected zone secured by an access portal (e.g., a reader and a locked door or an RFID sensor) a list of all users currently in the protected zone can be obtained by querying the physical access system and limiting the set of users to that group, thereby reducing the search space.

Invariably, some valid users will request access from workstations or during times that they have never (or rarely) requested access from in the past. In such cases, the system can attempt to validate the users through various techniques—one being a brute-force comparison of the user's credentials against every valid credential until a match is found. Such an approach, however, quickly becomes annoying for the user, especially for systems with a large number of users, as the time necessary for performing hundreds or thousands of biometric comparisons is greater than the amount of time a typical user is willing to endure for a login process. As a result, the invention facilitates the termination of the biometric authentication process (or terminates it automatically) and resorts to other authentication approaches to process the user's request for access.

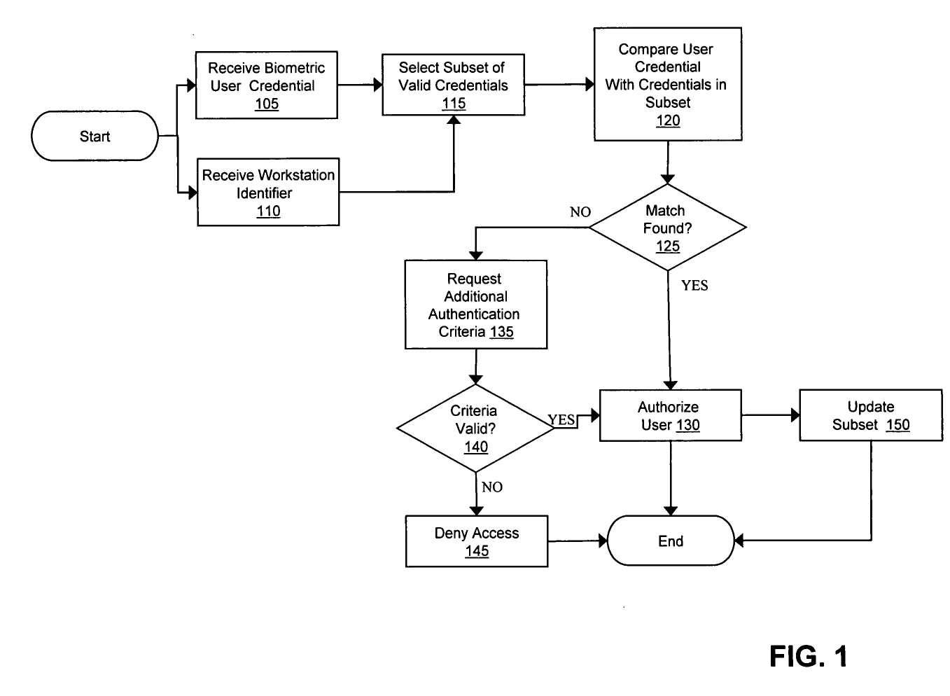

Referring to FIG. 1, in one embodiment of the invention an authentication server (described in more detail below) receives a biometric user authentication credential from a user attempting to login to a computer system (STEP 105). In conjunction with receiving the authentication credential, the server also receives one or more workstation identifiers (STEP 110) from the workstation. The server uses one or more of the workstation identifiers to identify and select a subset of valid biometric authentication credentials (STEP 115) against which the user-supplied credential will be compared (STEP 120) to determine if a match exists (STEP 125). If a match is found within the subset, the user is authorized and granted access to the system (STEP 130). However, instead of using the brute-force approach described above (e.g., searching through the entire database of credentials) when no match is found in the subset, the system terminates the biometric comparison process and requests that the user supply a different credential such as a password or code (STEP 135). Because a relatively short (4-10 character, for example) code requires fewer computational resources for validation than a complex biometric credential, the system limits the time required for user validation to a tolerably short time. The user then provides their password, token code, or other authentication criteria, and a validation check is performed (STEP 140). If the additional criteria is not found or deemed invalid for some reason, the users request is denied (STEP 145). If, on the other hand, the additional credential is valid, the user is granted access to the system (STEP 130).

In some embodiments, the biometric authentication credential supplied by the user that did not match one of the credentials in the subset is used to create a new record associating the user with that workstation, thus updating the subset (STEP 150). The new record can be permanent or temporary, allowing users and/or administrators to adjust one or more parameters that determine how long (hours, days, years, etc.) the new record is kept in the database. Therefore, if the user continues to use the same workstation or requests authentication from that workstation (or a workstation physically or logically related to the workstation), the new record is included in the initial subset and the user is authenticated using only her biometric credential. In addition, associating a user with one workstation based on a “first” authentication request allows the system to look for similarities within the dataset and to associate the user with other workstations that she may have never used, but, based on the data, have a high likelihood of using in the future. For example, if a user requests access from a workstation that is part of group of three (or more) workstations that are in close proximity to each other and essentially interchangeable (e.g., each offers access to the same server-based applications and/or data), it may be likely that in the near future, the user will request access from any one of the three, especially in cases where many users share the workstations. Thus, in addition to creating a data record (described in more detail below) associating the user's credential with the workstation from which the user requests authentication, the system creates additional records associating the credential with other workstations based on associations among the workstations.

The associations can be straightforward—i.e., the workstations are physically next to each other, or in some cases more complex. Unobvious or complex relationships among workstations can be uncovered through analysis of workflow and system usage histories. Such analysis may indicate that users requesting authentication from a particular workstation (or group of workstations) are likely to request authentication from another, seemingly unrelated workstation that may be in a different location or part of a different group than the first. For example, if a user uses a first workstation to receive instructions for performing an inspection at a particular location within a large hospital, there is a higher likelihood that he will request authentication from a workstation at that location in the near future than if no such instructions were received. Thus, when the user is authenticated to the system at the first workstation (using biometric or other authentication means), a record associating his biometric credential with the second workstation (or set of workstations) is also created. When the user then travels to that workstation and provides his biometric credential, he is already associated with that workstation; as a result the validation process is faster than if no such record existed.

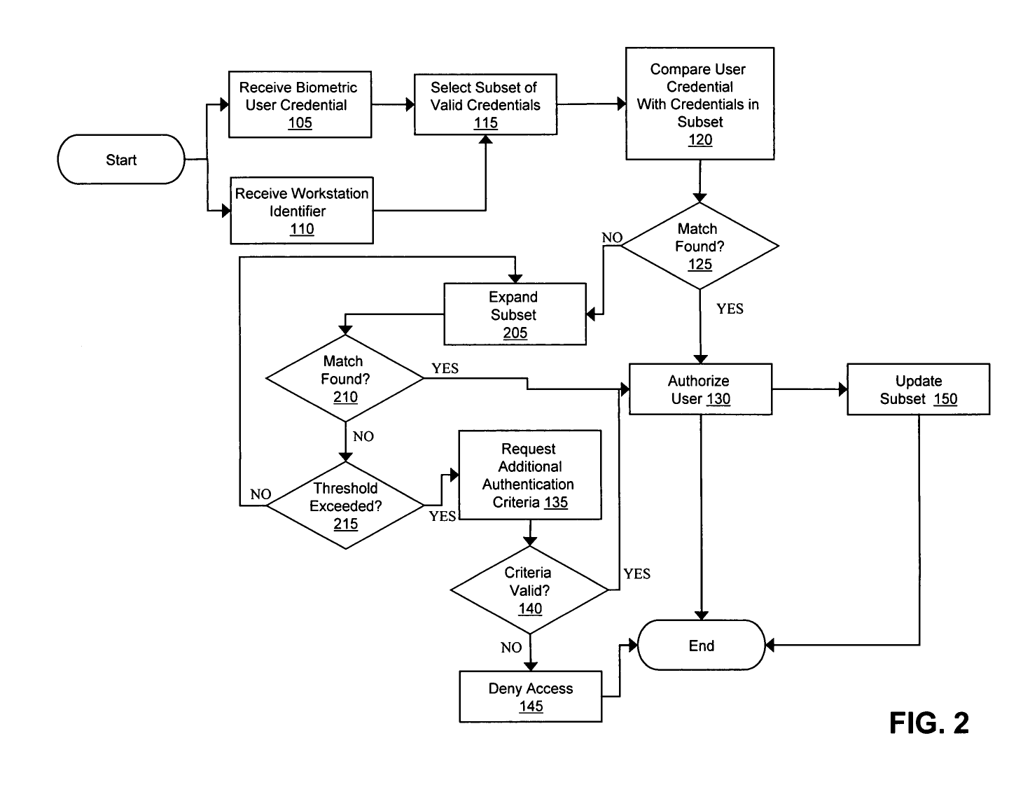

In some cases, and referring to FIG. 2, if a user requests authentication from a particular workstation, and no match is found among the credentials associated with that workstation, the subset may be expanded (STEP 205) to include credentials associated with workstations related to the workstation from which the request was received before resorting to requesting alternative authentication credentials. In particular, credentials associated with workstations that are in close physical proximity to the requesting workstation, are part of the same physical or logical grouping, or are associated with a common server, gateway, domain, router or subnet can be added to the subset. The process of increasing the universe of records to be searched can be repeated until a match is found (STEP 210), or, in some cases, until a time-based threshold is reached (STEP 215). For example, a user (or system administrator) may determine that if no match is found within three seconds, the system then prompts the user to supply the alternate authentication information.

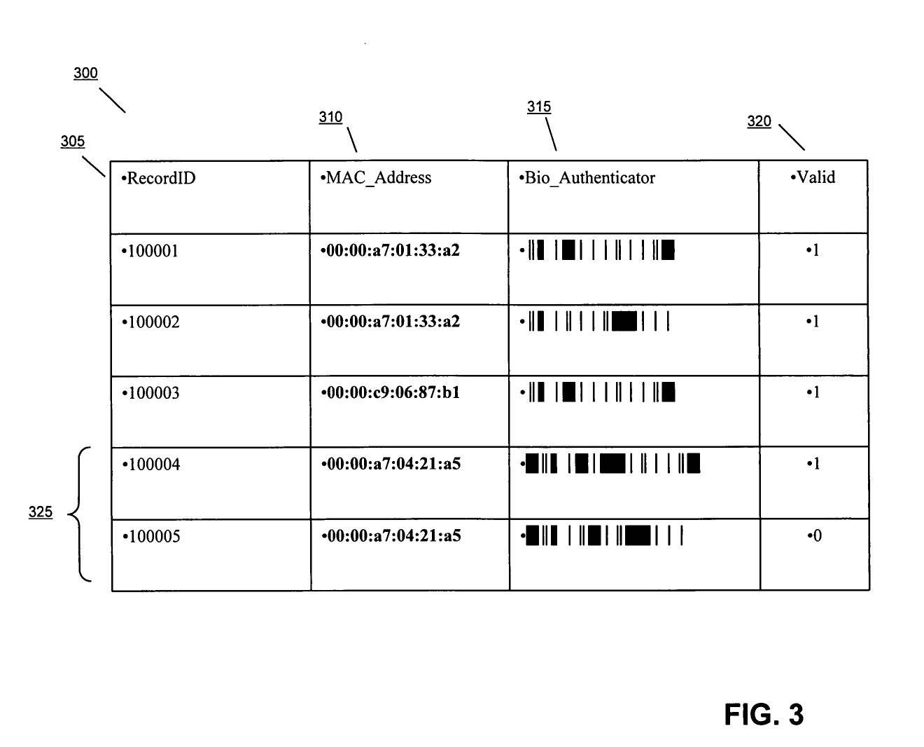

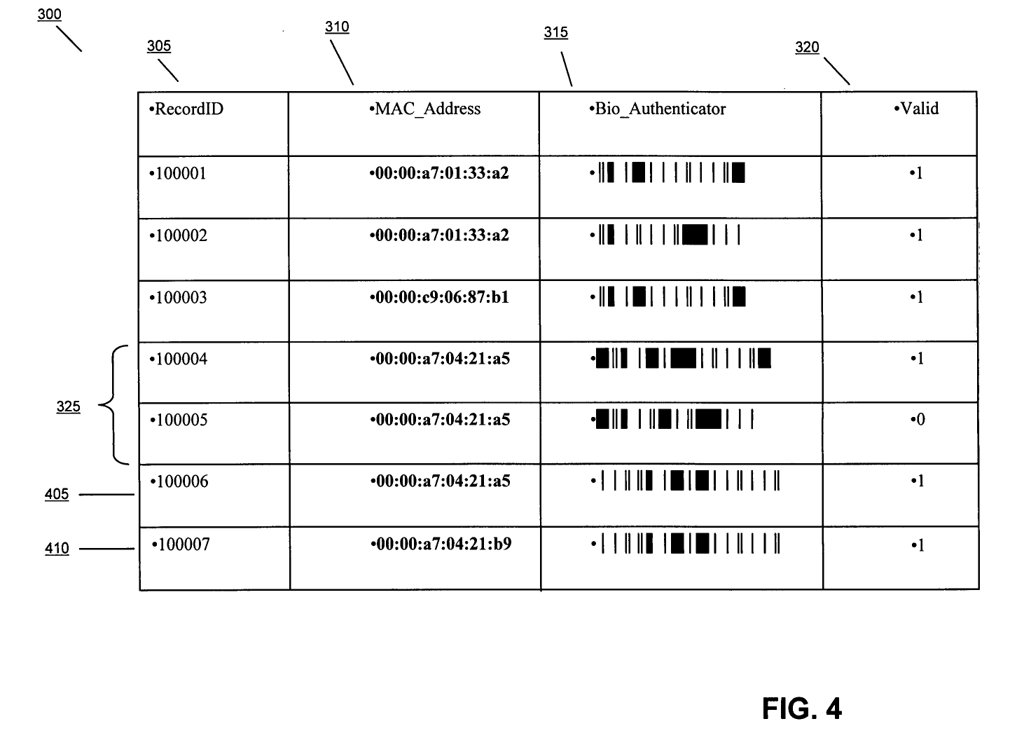

In conjunction with providing additional workstation information with the biometric authenticator, the authentication credentials are stored in such a manner that facilitates easy filtering and searching using the identifiers as parameters and/or indices. Referring to FIGS. 3 and 4, a data structure includes both the identifier (in this case, the MAC address) and the biometric criteria. In some embodiments where users work from multiple workstations, their biometric authenticators can be stored multiple times and associated with multiple workstations.

FIG. 3 illustrates exemplary records 300 from a database operating within a system according to the present invention. In contrast to conventional biometric authentication systems that include only biometric authentication data, one example of a data structure that may be used in implementing and operating the invention includes a RecordID field 305, a MAC_Address field 310, a Bio_Authenticator field 315 and a Valid field 320. As such, when an authentication request including the MAC address and biometric authentication criteria arrives at the authentication server, the system first finds the subset of records that match on the received MAC address. Because a MAC address comprises relatively few characters as compared to the data used to represent a biometric authentication credential, a subset 325 of records matching the MAC address can be identified more quickly than scanning the entire contents of the Bio_Authenticator field in the database.

For example, if a user requests access to a secure system from a workstation having a MAC address of 00:00:a7:04:21:a5, the system identifies records 100004 and 100005 as records likely to contain the biometric credential that will match the user-supplied credential. The user-supplied credential is then compared to the credentials in the Bio_Authenticator fields of records 100004 and 100005, and if a match is found, the system checks the status of the user, and if the value in Valid field 320 indicates that the credentials are valid, the authentication request is granted. If, however, the Bio_Authenticator fields of records 100004 and 100005 do not match the user-supplied credential, the user is instructed to provide alternative authentication information.

Referring to FIG. 4, once a user is authenticated using the alternative information, a new record 405 (100006) may then be added to the database associating MAC address 00:00:a7:04:21:a5 with the biometric authentication credential of that user. Furthermore, and as described above, additional records 410 can be created associating the user with other machines, based, for example, on workstation usage histories, time-based usage trends and/or other relationships identified among workstations.

In some embodiments, associations may be created due to exceptional or unusual user authentication requests. Such requests may be the result of a user visiting from another office, a temporary work assignment, or other event that, although valid, does not merit being included in the initial search subset when other users request access from that workstation. In this case, the system can periodically scan the database and purge records that were correctly created but represent anomalies nonetheless. For example, a user may request authentication from a remote location, and, after being validated using a credential other than his biometric credential, an association between that biometric credential and the workstation is created. However, the user may not return to that workstation for weeks, months, or even years, and thus the record can be safely deleted, thus maintaining a smaller search universe for subsequent authentication requests.

FIG. 5 depicts a system for accelerating user login and authentication using the techniques described above. In one embodiment, the user authentication system 500 includes at least one authentication server 505, and at least one client 510 from which a user is requesting to gain access to a secure system 515. As shown, the user authentication system 500 includes eight clients, but this is only for exemplary purposes, and it is intended that there can be any number of clients 510 in various configurations. For example, the clients can be virtually any type of computer workstation connected directly to the server 505, they can be part of a workgroup 520 that is connected to the server 505, or, in some cases, connected to a network 525 that is connected to the server 505. The client 510 is preferably a personal computer (e.g., a PC with an INTEL processor or an APPLE MACINTOSH) capable of running such operating systems as the MICROSOFT WINDOWS family of operating systems from Microsoft Corporation of Redmond, Wash., the MACINTOSH operating system from Apple Computer of Cupertino, Calif., and various varieties of Unix, such as SUN SOLARIS from SUN MICROSYSTEMS, and GNU/Linux from RED HAT, INC. of Durham, N.C. (and others). The client 510 can be such hardware as a smart or dumb terminal, network computer, personal data assistant, wireless device, information appliance, workstation, minicomputer, mainframe computer, or other computing device that is operated as a general purpose computer or a special purpose hardware device solely used for serving as a client 510 in the user authentication system 500.

Generally, clients 510 are operated by users of the system to access applications and data stored in the secure system 515. In various embodiments, the client computer 510 includes and/or is in communication with one or more biometric capture devices 530, either directly (using, for example a COM port, USB port, firewire port, wireless connection, or other similar connection means) or indirectly through another client 510, the server 505, or the network 525.

The communications network 525 connecting the clients 510, capture devices 530, the server 505 and the secure system 515 may include one or more processing units and operate via any media such as standard telephone lines, LAN or WAN links (e.g., T1, T3, 56kb, X.25), broadband connections (ISDN, Frame Relay, ATM), wireless links, and so on. Preferably, the network 525 can carry TCP/IP protocol communications, and HTTP/HTTPS requests made by the client 510 and the server 510 can be communicated over such TCP/IP networks. The type of network is not limited, however, and any suitable network may be used. Typical examples of networks that can serve as the communications network 525 include a wireless or wired Ethernet-based intranet, a local or wide-area network (LAN or WAN), and/or the global communications network known as the Internet, which may accommodate many different communications media and protocols.

In one embodiment, the server 505 includes a receiver module that provides an interface for communication among the clients 510 and an authentication module for facilitating, among other processes, user authentication in accordance with the methods described above. The system 500 also includes a biometric credential and data storage module 535, which stores authentication credentials and other data related to user login credentials and privileges in one or more databases. For instance, the data storage module 535 may store information relating to the users of the secure system 515, previously captured authentication credentials (both biometric and other credentials such as IDs and passwords), workflow data and workstation usage history. The data storage module 535 is typically implemented using a non-volatile storage medium (e.g., one or more hard disks and/or optical disks), may contain one central database or comprise separate databases for each type of data and/or serving different geographical locations, and provides the data to the authentication server 505. An example of the database server 535 is the MySQL Database Server by MySQL AB of Uppsala, Sweden, the PostgreSQL Database Server by the PostgreSQL Global Development Group of Berkeley, Calif., or the ORACLE Database Server offered by ORACLE Corp. of Redwood Shores, Calif.

In an alternate configuration, the functionality supplied by the authentication module can be performed by a client-resident agent residing on one or more of the clients in communication with the server 505 and secure system 515. In one embodiment, the agent implements the processes described above as a process running in RAM on a workstation in communication with the secure system. For example, when a user requesting authentication to the secure system 515 provides her biometric authentication credential at the client using, for example, the biometric capture device 530, the agent receives the biometric authenticator and one or more client identifiers, such as the MAC address, as described above. The agent transmits the identifier to the server 505, which returns a subset of valid biometric credentials to the agent, which, in turn, performs the comparison step, and, if successful, grants the user's access request. If unsuccessful, the agent requests alternative credentials (and ID, password, etc.) from the user. By transmitting (and in some cases storing, in RAM, for example) the subset at the client, the authentication process can be further accelerated, especially for those users that repeatedly use the same computer workstation and/or request system access from the same location or workgroup over time.

In some embodiments, the process of authenticating the user using a client-resident authentication agent is performed in accordance with the techniques and systems described in co-pending, commonly owned U.S. patent application Ser. No. 10/395/043, entitled “System and Method for Automated Login,” the entire disclosure of which is incorporated by reference herein.

The modules described throughout the specification can be implemented in whole or in part as a software program using any suitable programming language or languages (C++, C#, java, LISP, BASIC, PERL, etc.) and/or as a hardware device (e.g., ASIC, FPGA, processor, memory, storage and the like).

From the foregoing, it will be appreciated that the systems and methods provided by the invention afford an efficient method authenticating users to computer systems where the comparison of authentication credentials involves significant computing resources.

One skilled in the art will realize the invention may be embodied in other specific forms without departing from the spirit or essential characteristics thereof. The foregoing embodiments are therefore to be considered in all respects illustrative rather than limiting of the invention described herein. Scope of the invention is thus indicated by the appended claims, rather than by the foregoing description, and all changes that come within the meaning and range of equivalency of the claims are therefore intended to be embraced therein.

What is claimed is:

1. A method for authenticating a user to a computer system, the method comprising the steps of:
receiving a set of biometric authentication credentials;
receiving a biometric authentication credential attributed to the user;
comparing the received user biometric authentication credential to a subset of the set of valid biometric authentication credentials; and
requesting the user to provide an additional authentication credential if the received user biometric authentication credential does not match any of the valid authentication credentials in the subset.

2. The method of claim 1 wherein the set of biometric authentication credentials comprises one or more of fingerprints, retinal scans, facial scans, and voiceprints.

3. The method of claim 1 further comprising receiving an identifier associated with a computer.

4. The method of claim 3 wherein the identifier comprises one or more of a MAC address, an IP address and a digital signature of the computer.

5. The method of claim 3 wherein the subset is based on the identifier associated with the computer from which the biometric authentication credential was received.

6. The method of claim 1 wherein the computer system comprises one or more secure applications.

7. The method of claim 1 wherein the additional authentication credential comprises one or more of a user ID, a password, and a secure token.

8. The method of claim 1 further comprising authenticating the additional authentication credential.

9. The method of claim 8 further comprising granting access to the computer system based on the authenticated additional authentication credential.

10. The method of claim 8 further comprising adding the user biometric authentication credential to the subset.

11. The method of claim 10 wherein adding the user biometric authentication credential to the subset comprises creating an association between the user biometric authentication credential and an identifier associated with at least a computer from which the biometric authentication credential was received.

12. The method of claim 11 wherein the association facilitates a subsequent authentication of the user to the computer system using only the user's biometric authentication credential.

13. The method of claim 10 wherein adding the user biometric authentication credential to the subset comprises creating an association between the user biometric authentication credential and an identifier associated with a computer other than a computer from which the biometric authentication credential was received.

14. The method of claim 1 further comprising receiving a usage history of the computer.

15. The method of claim 14 wherein the usage history of the computer comprises time-referenced data relating user authentication request to a timestamp.

16. The method of claim 14 wherein the subset is based on the usage history of the computer from which the biometric authentication credential was received.

17. The method of claim 14 further comprising removing the user biometric authentication credential from the subset.

18. The method of claim 1 wherein the computer is not associated with the computer system.

19. The method of claim 1 further comprising:
(a) expanding the subset to include additional valid biometric authentication credentials; and
(b) prior to requesting the user to provide an additional authentication credential, repeating the comparison.

20. The method of claim 19 further comprising repeating steps (a) and (b) until a time threshold is reached.

21. The method of claim 20 wherein the time threshold is configurable.

22. The method of claim 1 wherein the subset is based on a set of users having been granted physical access to a computer within the computer system.

23. A system for authenticating a user to a secure computer system, the system comprising:
a data storage module for storing a set of biometric authentication credentials;
a receiver for receiving a biometric authentication credential attributed to the user; and
an authentication module for:
comparing the received user biometric authentication credential to a subset of the biometric authentication credentials; and
requesting the user to provide one or more additional authentication credentials if the received user biometric authentication credential does not match any of the authentication credentials in the subset.

24. The system of claim 23 wherein the data storage module, receiver and authentication module reside on separate physical devices.

25. The system of claim 23 wherein the receiver is further configured to receive an identifier associated with the computer.

26. The system of claim 25 wherein the authentication module is further configured to create the subset based on the identifier associated with the computer.

27. The system of claim 23 wherein the receiver module is further configured to receive a usage history of the computer.

28. The system of claim 27 wherein the authentication module is further configured to create the subset based on the usage history of the computer.

29. The system of claim 23 wherein authentication module is further configured to authenticate the user to the computer system based on the additional authentication credential.

30. A system for authenticating a user to a secure computer system, the system being responsive to a biometric capture device and a server, and comprising an authentication agent residing on a computer in communication with a secure computer system, the agent being configured to:
receive one or more biometric authentication credentials from the capture device;
receive from the server a subset of a set of biometric authentication credentials representing users of the secure computer system;
compare the received biometric authentication credential to the subset; and
request the user to provide one or more additional authentication credentials if the received biometric authentication credential does not match any of the authentication credentials in the subset.

31. The system of claim 30 wherein the agent is further configured to receive an identifier associated with the computer and transmit the identifier to the server.

32. The system of claim 31 wherein the server is further configured to create the subset based on the identifier associated with the computer.

33. The system of claim 30 wherein the agent is further configured to receive a usage history of the computer and transmit the usage history to the server.

34. The system of claim 33 wherein the server is further configured to create the subset based on the usage history of the computer.

35. The system of claim 30 wherein the agent is further configured to authenticate the user to the secure computer system based on the additional authentication credentials.

36. The system of claim 30 wherein the subset is stored in RAM of the client.

37. An article of manufacture having computer-readable program portions embodied thereon for authenticating users to a secure computer system, the article comprising computer-readable instructions for:
receiving one or more biometric authentication credentials from a biometric capture device;
receiving, from a server, a subset of a set of biometric authentication credentials representing users of the secure computer system;
comparing the received biometric authentication credential to a subset of the biometric authentication credentials; and
requesting the user to provide one or more additional authentication credentials if the received biometric authentication credential does not match any of the authentication credentials in the subset.

38. The article of manufacture of claim 37 further comprising computer-readable instructions for receiving an identifier associated with a computer within the secure computer system.

39. The article of manufacture of claim 38 further comprising computer-readable instructions for creating the subset of the valid biometric authentication credentials based on the identifier associated with the computer.

40. The article of manufacture of claim 37 further comprising computer-readable instructions for receiving a usage history of a computer within the secure computer system.

41. The article of manufacture of claim 40 further comprising computer-readable instructions for creating the subset of the valid biometric authentication credentials based on the usage history of the computer.

42. The article of manufacture of claim 37 further comprising computer-readable instructions for authenticating the user to the computer system based on the additional authentication credentials.
